(19) United States
(12) Patent Application Publication
(10) Pub. No.: US 2015/0381383 A1
(43) Pub. Date: Dec. 31, 2015

(54) Mobile "Pixel" Display and Positional Sound System for Dynamic Social Environments

(71) Applicant: Bennett Hill Branscomb, Ingleside, TX (US)

(72) Inventor: Bennett Hill Branscomb, Ingleside, TX (US)

(21) Appl. No.: 14/751,335

(22) Filed: Jun. 26, 2015

Related U.S. Application Data
(60) Provisional application No. 62/017,695, filed on Jun. 26, 2014.

(51) Int. Cl. H04L 12/28; G10K 15/08; H04S 7/00

(52) U.S. Cl. CPC H04L 12/2812; H04S 7/303; G10K 15/08; H04L 12/282; H04L 2012/2841

(57) ABSTRACT

A computing control system, a mobile application installed in a plurality of mobile devices, one or more networks, and position technology may be used to render and display real-time imagery, trigger local devices using wireless technology (e.g., Bluetooth) for exchanging data over short distances from fixed and mobile devices, and build personal area networks (PANs) or similar addressable device triggers, and/or sound in 3-D for point(s)-to-multipoint(s) for social entertainment, advertising, marketing and fan experience enhancement.

### CROSS-REFERENCE TO RELATED APPLICATIONS

This application claims the benefit of U.S. Provisional Application No. 62/017,695, filed on Jun. 26, 2014.

### STATEMENT REGARDING FEDERALLY SPONSORED RESEARCH OR DEVELOPMENT

Not Applicable

### BACKGROUND OF THE INVENTION

### Field of the Invention

The present invention generally relates to wireless communications. More particularly, it relates to remotely-triggered displays comprised of a plurality of personal electronic devices in a dynamic, mobile array.

### BRIEF SUMMARY OF THE INVENTION

The present invention utilizes a Conductor(s) computing control system, a Mobile App installed in mobile devices, one or more data communication networks, and position technology to render and display real-time imagery, trigger local devices using wireless technology (e.g., Bluetooth) for exchanging data over short distances (e.g., using short-wavelength UHF radio waves in the ISM band from 2.4 to 2.485 GHz) from fixed and mobile devices, and building personal area networks (PANs) or similar addressable device triggers, sound in 3-D for point(s) to multipoint(s) for social entertainment, advertising, marketing and fan enhancement.

### DETAILED DESCRIPTION OF THE INVENTION

This invention involves a point(s)-to-multipoint system whereby a computing device(s), herein referred to as the “conductor(s)”, connected to a network(s) is in data communication with a plurality of mobile smart devices that have multimedia capability. This system provides for a distributed application (e.g., Mobile App), which may be downloaded as a mobile application with independent, but connected processing intelligence, location information, such as GPS, and smart software, which describes and controls the multimedia capabilities (input/output) of each device. Examples of these devices are mobile smart phones, tablets and other processor-based devices that are in communication through a local wireless capability and/or larger, wireless networks as provided under data service plans by the major telecommunication carriers.

As a derivative of this system, a Mobile App according to the invention may be designed to also be in communication with an independently-addressed, localized audio or multimedia controller using Bluetooth or similar technology. The purpose of the additional localized controller is to improve the value of the multimedia experience delivered at each “3-D pixel point”. As an example, a company may produce a simple, battery-operated controller that may be worn, and is in communication with a signal mobile device addressed to this worn controller. As an example, a Bluetooth controller may be connected to the Mobile App and used to manipulate lights, which are sewn into clothing for a personal multimedia display. The same device may be used to send sound to speakers via small amplifiers. Another example is the delivery of a command to a small portable “smoke device” to create an atmosphere of “smoke rings.” The Bluetooth device may be used to set off multimedia devices simply from the movement of the mobile device or relative to the position of the mobile device(s) to staged display devices. These options and devices may be generally categorized by the six human senses and used for the purpose of enhancing a social, marketing, and overall point(s)-to-many-point(s) mass expression.

Motion multimedia (video sound) is spatial as it is delivered. Resolution is determined in screen technology by the density of “pixels” and the utilization of volume to create the spatial movement of sound delivered by surround sound technology for effect is examples for this invention. One aspect of this invention utilizes each mobile device controlled as described herein as a “virtual pixel” with x,y,z position in space connected to a dynamic computerized conductor(s) virtual space.

Devices (screens for visuals and speakers positioned in multiple locations) are made with a predetermined size and density of pixel/number and height of speakers and sold based upon improving pixel density and quality of sound/type audio device (example is a low bass speaker/versus high end speaker). A pixel has a specific x, y dimension on a 2-D display screen. Audio systems use channels for each instrument and volume to effectively “move” sound between speakers that are separated by distance and are of different types in the audio spectrum. This art is well understood—e.g., video walls which are assemblies of flat display screens in a 2-D array. This invention anticipates a similar situation, but in 3-D space, where each device is mobile, addressable, controllable and located at a known point in space. And where each device contains a similar Mobile App as well as may have independently extensibility by utilizing its own addressable local network or “last wireless controller” as taught by Bluetooth Technology.

This invention utilizes a computing-system-controlled dynamic software system that is in communication through one or more networks with mobile devices in real time. It determines by position in real time and density of devices and their characteristic spatially and image pixel density in a 3-D space, which is within a space or collection of devices in communication with a central conductor platform(s). As mobile devices move, this system constantly updates their position thereby replacing the effective position of one “mobile pixel or sound pixel” with one which has moved and is now in a new part of the location and respective sound or image “pixel”.

The purpose of this invention is to deliver any kind of sound or dynamic visual experience in a social atmosphere anticipating interactively a collective of people/moving devices. Examples include concerts, sports events, marches, and other kinds of display systems that might be dynamic and made up of individual mobile sound or visual devices.

The conductor system may be located on site in proximity of these devices using a localized wireless connection, in a remote location using virtual carrier broadband services to communicate to the individual devices, to the localized conductor system which is then in communication with the individual devices; or a hybrid of the two, where the remote master conductor communicates directly to the Mobile App, the local conductor, and where the local conductor is in communication with the Mobile App as well.

The purpose of the system consisting of multiple and complex conductors is to create interactivity and art in shared social space. This system may have a significant real time dynamic processing requirements both to generate an accurate three-dimensional model of each device location and purpose, but deliver accurate, recalculated, multimedia components as a social experience.

Three-dimensional rendering of video/audio and other multimedia requires processing multimedia data at rates where the display is seamless to human sense receptors. The systems, processors, network latencies, processor speeds, and active store forward in both virtual data memory in the mobile devices, conductor system localized, and the remote master conductor in communication through carrier networks may be optimized to generate very high three-dimensional (3-D) multimedia experiences. Therefore, each device may be in constant communication and systems developed to improve and optimize the experience.

One example of such an experience is the generation of a visual similar to what has been demonstrated in a football stadium. It is common to have people seated in certain seats (3-D registry in stadium space) to be given a certain colored sign. Upon a command, people display their individual colored signs (positioned pixels) in a certain way thereby creating a macro-visual rendered image incorporating movement in 3-D image space. Another example, but not controlled from an audio motion perspective, is where the conductor (quarterback) waves his arms up to the stadium crowd to have them voice or cheer. This effect creates a massive and immediate combined multimedia event for specific purposes. This invention utilizes these ideas, but advances them in many ways using advanced computer systems in communication, but conducted. Distributed image rendering for mobile smart mobile devices for real time multimedia display as individual display pixels for social displays is one of many dimensional elements that may be developed as part of the art.

Another example in this system is to process the audio channels from the instruments and microphones from individual musicians live as the play in a concert hall. This information may be processed through sound equipment into the local system conductor for the purpose of generating multimedia point-to-multi-point to the mobile application. This information may be collected via the speaker of each device into the Mobile App as well for similar reasons and processed to display and communicate the experience.

In summary, this invention utilizes a Conductor(s) computing control system, a Mobile App installed in mobile devices, a multiplicity of networks and position technology to render and display real time imagery, trigger local devices using Bluetooth or similar addressable device triggers, sound in 3-D for point(s) to multipoint(s) for social entertainment, advertising, marketing and fan enhancement.

The foregoing presents a particular embodiment of a system embodying the principles of the invention. Those skilled in the art will be able to devise alternatives and variations which, even if not explicitly disclosed herein, embody those principles and are thus within the invention's spirit and scope. Although particular embodiments of the present invention have been shown and described, they are not intended to limit what this patent covers. One skilled in the art will understand that various changes and modifications may be made without departing from the scope of the present invention as literally and equivalently covered by the following claims.

What is claimed is:

1. A method for creating a display comprising:
receiving position information from a plurality of portable, personal electronic devices each having a screen display;
calculating a picture element for one or more screen displays;
transmitting a command to a selected personal electronic device to display a certain image on its display screen.

2. A method for creating an audible sound comprising:
receiving position information from a plurality of portable, personal electronic devices each having at least one speaker;
calculating a sound element for one or more selected speakers;
transmitting a command to one or more selected personal electronic devices to emit an audible signal corresponding to the calculated sound element.

3. A method for creating an audio/visual display comprising:
receiving position information from a plurality of portable, personal electronic devices each having a screen display and at least one speaker;
calculating a picture element for each screen display;
calculating a sound element for one or more selected speakers;
transmitting a command to a selected personal electronic device to display a certain image on its display screen; and,
transmitting a command to one or more selected personal electronic devices to emit an audible signal corresponding to the calculated sound element.

4. The method recited in claim 1 wherein the portable, personal, electronic devices are incorporated into one or more articles of clothing.

5. The method recited in claim 1 wherein transmitting a command to a selected personal electronic device to display a certain image on its display screen occurs in response to movement of the personal electronic device.

6. The method recited in claim 5 wherein movement of the personal electronic device is movement relative to a staged display device.

7. The method recited in claim 2 wherein transmitting a command to one or more selected personal electronic devices to emit an audible signal corresponding to the calculated sound element occurs in response to movement of the personal electronic device.

8. The method recited in claim 2 wherein calculating a sound element for one or more selected speakers comprises simulating the placement of an auditory cue in a virtual 3D space.

9. The method recited in claim 2 wherein calculating a sound element for one or more selected speakers comprises creating a reverberated signal.
